(19) United States
(12) Patent Application Publication
(10) Pub. No.: US 2017/0018991 A1
(43) Pub. Date: Jan. 19, 2017

(54) Electric Machine

(71) Applicant: CONTINENTAL AUTOMOTIVE GMBH, Hannover (DE)

(72) Inventors: Detlef LUDWIG, Diepersdorf (DE); Sebastian ROGGE, Radebeul (DE); Edmund SCHIRMER, Nürnberg (DE)

(21) Appl. No.: 15/300,828

(22) PCT Filed: Mar. 19, 2015
(86) PCT No.: PCT/EP2015/055764

§ 371 Date: Sep. 30, 2016

(30) Foreign Application Priority Data
Mar. 31, 2014 (DE) 10 2014 205 930.5

(51) Int. Cl. H02K 5/20; H02K 11/33; H02K 5/15

(52) U.S. Cl. CPC H02K 5/20; H02K 5/15; H02K 11/33

(57) ABSTRACT

An electric machine includes a housing, a stator, and a rotor. The stator includes the rotor. The rotor includes a shaft. The electric machine is equipped with power electronics inside the housing. In addition, the electric machine includes a cooling duct that extends along a longitudinal section and a front section. The longitudinal section extends along a hollow cylinder, through an interior of which extends an axis of rotation of the shaft. The front section extends towards the shaft.

### TECHNICAL FIELD

The disclosure relates to a possibility with which heat loss may be removed in a simple manner from an electric machine.

### BACKGROUND

Electric machines may be cooled by means of a guided heat medium to be able to effectively dissipate heat loss, for example, at power applications. Since, however, a plurality of components may generate heat loss within an electric motor, then the components in addition to the stator have to be cooled. As such, the conduction of the heat medium may need a high structural outlay.

### SUMMARY

One aspect of the disclosure provides an electric machine by which waste heat is easily removed from the electric machine. The electric machine includes a housing, an end side section, a rotor, a stator, and a cooling duct. The housing includes power electronics and is defined by a longitudinal section and an end side section. The rotor includes a shaft. The stator embraces the rotors. In addition, the cooling duct extends along the longitudinal section and along the end side section. The longitudinal section extends along a hollow cylinder, through the interior of which the axis of rotation of the shaft leads, and the end side section extends toward the shaft.

Implementations of the disclosure may include one or more of the following optional features. In some implementations, the longitudinal section is bounded by a circumferential surface of the stator on one side and a wall of the housing on the other side. The end side section may be bounded by an end side of the stator on one side and of the power electronics on the other side. In some examples, the power electronics extend along an annular surface, through the center of which the shaft pushes. The power electronics may have a cooling surface which bounds the end side section.

In some implementations, the longitudinal section merges directly into the end side section. In addition, the cross section of the longitudinal section may extend between the stator and the housing, and the cross section of the end side section may extend between the stator and the power electronics.

The longitudinal section may include a first subsection bounded by a circumference of a winding body, and a second subsection bounded by a circumference of a winding head of the stator. In some examples, the first subsection is connected via the second subsection to the end side section, and the end side section is bounded by an end side of the winding head.

The electric machine may further include a bearing shield having an inner side bearing the power electronics. In addition, the shaft may be mounted rotatably by means of a bearing of the bearing shield, and the shaft may push through the bearing shield.

In some implementations, the longitudinal section is divided into at least two parts by at least one wall. For example, the wall firstly extends from the stator to the housing and secondly extends in a direction along which the shaft runs.

The electric machine may also include a heat medium inlet and a heat medium outlet, between which the cooling duct extends. In some examples, the heat medium inlet and the heat medium outlet are arranged on the same end side of the housing. For example, the heat medium inlet and the heat medium outlet are arranges on an end side which is opposite the end side on which the end side section is provided. In some examples, the heat medium inlet and the heat medium outlet run through a further bearing shield which, with respect to the electric machine is opposite a bearing shield which bounds the end side section and in particular bears the power electronics.

In some examples, the longitudinal section extends along a plurality of cut hollow cylinders. The plurality of cut hollow cylinders are divided into sectors in the direction of longitudinal direction of the shaft. The cut hollow cylinders and end sides of different hollow cylinders may be connected to one another via the end side section.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 illustrates a cross section view through an exemplary electric machine.

FIG. 2 illustrates a top view of an exemplary electric machine.

Like reference symbols in the various drawings indicate like elements.

### DETAILED DESCRIPTION

A cooling duct may be produced in a particularly simple manner if the cooling duct has a longitudinal section and an end side section. For example, the longitudinal section extends along a stator of an electric machine and the end side section of the cooling duct that is connected to the longitudinal section is guided along a surface through which the axis of rotation of the electric machine extends. The longitudinal section and therefore the flow of a heat medium there runs in the axial direction, while the end side section and therefore the flow of the heat medium there runs in the radial direction or at least in a direction perpendicular to the axial direction. The axial direction corresponds to the direction of longitudinal direction of the (shaft of the) electric machine. The flow in the end side section is conducted by the latter along secants, which are guided through the end side section.

The end side section conducts the heat medium substantially perpendicularly to the direction along which the heat medium is conducted in the longitudinal section, as a result of which not only the circumferential surface of the stator, but also components on the end side of the stator (for example the winding head and/or power electronics) may be cooled. As such, the end side section permits cooling on both sides of the end side section, that is to say on the side of the stator for cooling the winding head and on the opposite side of the end side section (in the direction of the axis of rotation of the electric machine), on which side power electronics or a bearing shield may be located.

This equally permits a compact construction and simple guidance of the heat medium. Since the cooling duct may be divided into a longitudinal section and an end side section at an angle thereto, differently oriented surfaces (for example the circumferential surface of the stator and the end-side winding head or the end-side power electronics) and therefore also different components may be cooled with the same cooling duct. Since the longitudinal section may merge directly here into the end side section, where the longitudinal section and the end side section reproduce the outer basic shape of the electric machine (apart from an opposite end side), the configuration of the cooling duct is particularly simple and in particular does not need any additional fluid engineering measures, such as distributors or the like.

The section of the cooling duct that extends along (the outer side of) the electric machine, that is to say in the direction of the axis of rotation or in the direction of the shaft of the electric machine, is referred to as a longitudinal section. The end side section, which may also be referred to as transverse section, extends through the end side substantially radially or along secants with respect to the axis of rotation or the shaft. As a result, the end side section and longitudinal section form the boundary for a space in which components of the electric machine (stator, rotor, and also winding head) may be located, where use is made in particular of both sides of the end side section (as seen in the direction of the axis of rotation or of the shaft) in order to fit components there, the heat loss of which is to be removed (i.e. the heat loss of the winding head and of the power electronics). Since the power electronics extend parallel to the plane along which the winding head extends (and which is perpendicular to the shaft), electric connections between the power electronics and the winding head or the stator windings may be produced in a simple manner.

In some implementations, an electric machine is equipped with a housing, a stator, and a rotor. The stator includes the rotor. The electric machine may include an internal rotor. However, other examples as an external rotor are possible as well, where, with respect to the design, the rotor replaces the stator, and vice versa. The rotor may include a shaft. The axis of rotation of the electric machine may extend through the latter. The axis of rotation corresponds to the longitudinal axis of the electric machine or is parallel thereto.

In some implementations, the electric machine is furthermore equipped with power electronics. The power electronics are arranged within the housing. The power electronics include in particular at least one (single- or multi-phase) power activation stage which supplies the stator and optionally also the rotor with current. The power end stage includes power semiconductors, for example, power transistors, such as IGBTs or MOSFETs, and/or power diodes. The power end stage may furthermore have additional power components, for example power capacitors, power resistors, and/or power inductors. The power end stage may furthermore be equipped with a heat sink which in particular has a cooling surface adjacent to the cooling duct described below (in particular to the end side section thereof) or is at least connected thereto in a heat-transmitting manner. At least one section of a surface of the power electronics or the entire surface of the power electronics is adjacent to the end side section or is connected thereto in a heat-conducting manner. The heat sink and/or the power electronics are electrically insulated from the cooling duct, for example by means of an insulating layer which extends along the cooling surface of the power electronics, and/or by means of insulating elements on the power semiconductors.

The electric machine has a cooling duct. The latter is located within the housing. The cooling duct extends along a longitudinal section and along an end side section. The longitudinal profile of the cooling duct therefore includes a division into at least one longitudinal section and at least one end side section. The longitudinal section leads along the circumferential surface of the stator. The end side section leads along an end side of the stator or of the electric machine (but within the housing). The end side section leads in particular along a bearing shield. The end side section furthermore leads in particular along an inner side (i.e. the side facing the stator) of the stator, for example along a winding head of the stator.

In some examples, the longitudinal section extends along a hollow cylinder or is designed in the form of a hollow cylinder or has an enveloping surface which has the form of a hollow cylinder. The hollow cylinder is in particular a circular cylinder, but may also have a different cross-sectional shape (oval, ellipsoid, polygonal, polygonal with rounded corners, . . . ). The shaft is guided through the interior of the hollow cylinder. The longitudinal axis of the electric machine or the axis of rotation may therefore extend through the interior of the hollow cylinder and corresponds in particular to the longitudinal axis of the hollow cylinder. The circular cylinder and the rotor (or else the stator) may be arranged concentrically with respect to each other.

The end side section extends toward the shaft. The shaft or the longitudinal axis of the electric machine (i.e. the axis of rotation) extends through a plane, in the direction of which the end side section extends. The shaft or the longitudinal axis of the electric machine may be in particular substantially perpendicular to the plane. The end side section may have the form of a ring, through the inner free area of which the shaft or the longitudinal axis extends. The ring may be substantially circular or circular-cylindrical, in particular on the surface facing the shaft, where the circular form may also be interrupted by recesses or protrusions.

In some examples, the height of the end side section (as seen in the direction of the longitudinal axis of the electric machine) may be constant. However, in other examples, the height of the end side section is variable, in particular if the winding head and/or the power electronics are adjacent to the end side section with a surface which is not flat. The end side section may be bounded in height by the stator or the winding head thereof on one side and by the power electronics or the bearing shield. The end side section may extend as far as the shaft or in the direction thereof. The end side section may be connected in such a manner that heat medium (i.e. a cooling medium, such as gas or liquid, for example air, oil or water) flowing therethrough is conducted in the direction of the shaft. The longitudinal section is connected in such a manner that heat medium flowing therethrough is conducted along the circumferential surface of the stator. The direction of flow in the longitudinal section leads along a lateral surface of a cylinder, while in the end side section, the direction of flow leads along an end side of the cylinder. The cylinder and the hollow cylinder may be a straight cylinder or a cylinder cut away obliquely.

In some examples, the longitudinal section is bounded by a circumferential surface of the stator on one side and by a wall of the housing on the other side. The wall of the housing may be a single wall, a double wall, or multiple wall. The inner side of the wall forms (circumferentially) the outer side of the longitudinal section. The outer side of the stator (or of a winding body which surrounds the stator) forms (circumferentially) the outer side of the longitudinal section. On an end side of the longitudinal section, the latter is connected to the end side section, in particular to a (stator-side) surface of the end side section, which surface extends in the direction of the shaft. The surface can correspond to the end side (mentioned below) of the stator or to an outwardly facing continuation of the end side of the stator.

In some implementations, the end side section is bounded by an end side of the stator on one side and the power electronics on the other side. For example, the end side section is bounded on the side of the stator by a winding head (or an electric insulating layer adjacent to the winding head) of the stator. Furthermore, the end side section, as already mentioned, may be adjacent to a cooling surface (for example of a heat sink) of the power electronics, the cooling surface facing the stator. The power electronics or the cooling surface thereof and the stator or the winding head thereof are opposite each other. The end side section is provided in the gap between the stator and the power electronics. The gap between the stator and the power electronics extends in a direction which corresponds to the direction of the longitudinal axis or to the direction of longitudinal direction of the shaft or to the direction of the axis of rotation. The end side section may be connected in order to conduct heat medium perpendicularly to the direction of the gap. In contrast thereto, the longitudinal section is connected in order to conduct heat medium along this direction (or along a circumferential surface or casing of the stator).

In some examples, the power electronics extend along an annular surface, through the (free) center of which the shaft pushes. The annular surface may correspond to a circular ring surface or may have a different basic form, for example oval, ellipsoid, polygonal or polygonal with rounded corners. In particular, the power electronics may be divided up into a plurality of segments, each segment extending only over a sector of a circle or a sector of a ring on an end side of the electronic machine. The segments may be distributed circumferentially on the end side. The power electronics may have a cooling surface which bounds the end side section (in a direction facing away from the stator).

The longitudinal section may merge directly into the end side section. In some examples, connecting elements are arranged at the transition provided in this manner, the connecting elements provide a direct fluid connection between the two sections of the cooling duct, for example a wall extending toward the shaft (or toward the axis of rotation) with an opening which connects the two sections. The cross section of the longitudinal section extends between the stator and the housing. This cross section therefore corresponds to that of the hollow cylinder or corresponds to the cross section of an envelope which surrounds the hollow cylinder. The cross section of the end side section extends between the stator and the power electronics and therefore in the direction of the shaft or the abovementioned gap. For example, the surface, the normal of which corresponds to the direction of flow, which predetermines the cooling duct (on account of the connection thereof to connections), is considered to be the cross section. The normals of the cross sections of the two sections are substantially perpendicular to each other.

The longitudinal section may have a first subsection (as viewed in the longitudinal direction of the electric machine), which is bounded by a circumference of a winding body. The winding body includes the stator. The longitudinal section can furthermore have a second subsection (as viewed in the longitudinal direction of the electric machine) which is bounded by a circumference of a winding head of the stator. The circumference of the winding body and the circumference of a winding head form a boundary toward the longitudinal axis of the electric machine for the first and the second subsection. The two subsections are outwardly bounded by the housing, in particular by an inner side of the housing. The first subsection and the second subsection are connected to each other and preferably merge (directly) into each other. The second subsection is connected, preferably directly, to the end side section. The two sections preferably merge into each other preferably directly or via a connecting element, such as an opening in a wall running on the end side. The first subsection is connected via the second subsection to the end side section. A heat medium inlet or a heat medium outlet can be provided at an end of the first subsection, which end is opposite that end of the first subsection which is connected to the second subsection. The end side section is bounded by an end side of the winding head. The end side can lie in a plane in which, furthermore, a transition or a connection between the longitudinal section and the end side section is arranged. The transition or the connection lies in an extension facing away from the shaft or in an elongation of the end side.

In some implementations, the electric machine has a bearing shield equipped with an inner side that bears the power electronics. Recesses in which the power electronics are arranged may be provided in the bearing shield. The recesses are on a side of the bearing shield that faces the stator or the winding head. A further bearing shield may be provided at the opposite end of the electric machine, for example, at an end of the longitudinal section that is opposite that end of the longitudinal section that is connected to the end side section of the cooling duct. The shaft may be rotatably mounted by a bearing of the bearing shield (which bears the power electronics). Furthermore, the shaft may push through the bearing shield that bears the power electronics. The power electronics or parts thereof (for example the power transistors) may be provided in circumferentially distributed segments of the bearing shield. For example, 3, 6, 9 (or a further multiple of three) segments are provided. The segments may be of identical design and may be arranged on different segments (offset at an angle to one another) of the bearing shield.

In some implementations, the longitudinal section may be divided into at least two parts by at least a wall. As a result, the longitudinal section may form an outward duct to the end side section and a return duct from the end side section. The wall may run rectilinearly at least in sections, wherein, however, a meandering profile may also be provided. The direction of longitudinal direction of the wall runs on the circumferential surface of the stator or on a casing that reproduces the circumferential profile of the stator or of the inner side of the housing. The wall therefore may extend in a direction along which the shaft runs. Furthermore, the wall extends (in the direction of transverse direction of the wall) from the stator to the housing. In some examples, the wall connects the stator or the winding body (fluid-tightly) to the housing. The wall may connect the outer side (of the circumferential surface) of the stator fluid-tightly to the inner side of the housing. As such, the wall bounds the cooling duct within the longitudinal section. In other words, the wall is configured to conduct the heat medium. The wall together with the inner side of the housing and the outer side (the circumferential surface) of the stator forms the circumferential boundary of the longitudinal section of the cooling duct.

Furthermore, in some implementations, the electric machine has a heat medium inlet and a coolant outlet. The cooling duct extends there between. The cooling duct may connect the heat medium inlet to the coolant outlet. The heat medium inlet and the coolant outlet may be arranged on the same end side of the housing, for example, on an end side that is opposite that end side on which the end side section is provided. The heat medium inlet and the coolant outlet may be provided at opposite ends of the electric machine or at the same end of the electric machine (as seen in the longitudinal direction of the electric machine). The heat medium inlet and the coolant outlet may be arranged on opposite end sides (for example, on opposite bearing shields) of the electric machine, or, alternatively, on the same end side (in particular on the same bearing shield).

In some implementations, the heat medium inlet and the coolant outlet run through a further bearing shield which, with respect to the electric machine, is opposite a bearing shield which bounds the end side section and in particular bears the power electronics.

The longitudinal section may extend along a plurality of cut hollow cylinders that are divided into sectors in the direction of the longitudinal direction of the shaft. The cut hollow cylinders and end sides of different cut hollow cylinders are connected to one another via the end side section. As a result, different cut hollow cylinders form an outward duct and a return duct. The cut hollow cylinders are produced in particular by a wall that extends from an outer side of the stator to an inner side of the housing. This wall may extend in one or in a plurality of planes in which the shaft or the longitudinal axis of the electric machine lies.

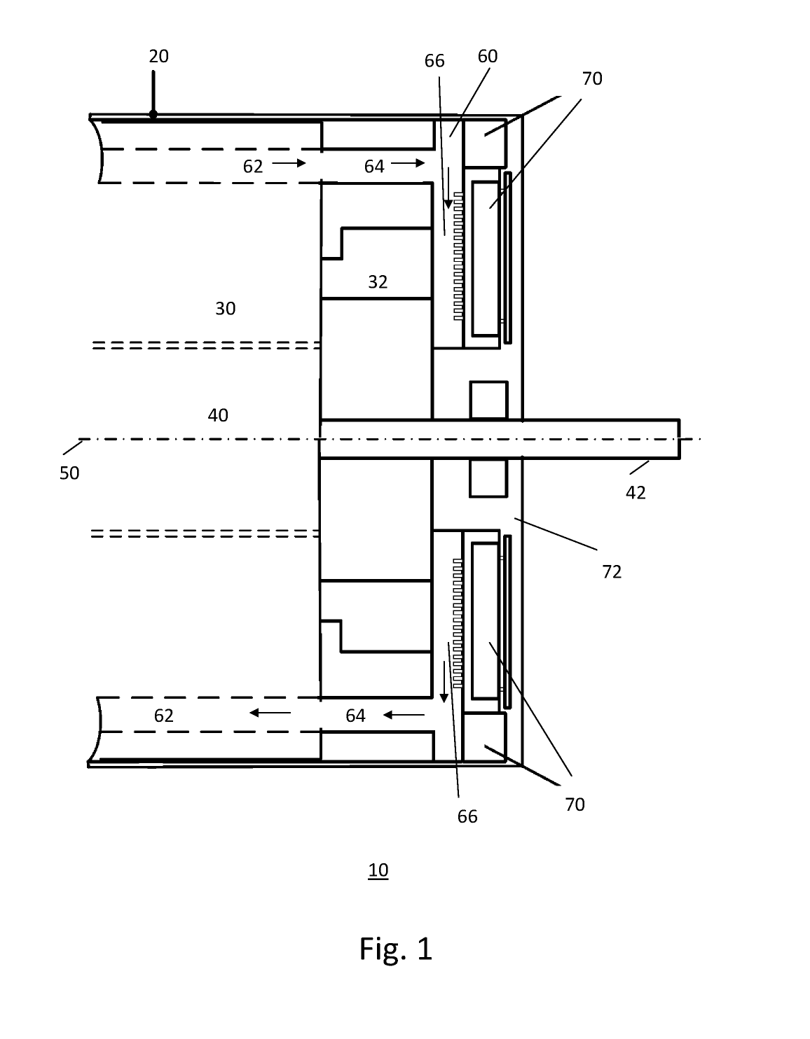

Referring to FIG. 1, an electric machine 10 includes a housing 20, a stator 30, 32 and a rotor 40, 42. The cross section illustrated in FIG. 1 runs longitudinally through the electric machine 10, in particular through the shaft or axis of rotation 50 of the electric machine 10. FIG. 1 illustrates a partial view of the electric machine that includes an end side or a bearing shield of the electric machine.

The rotor 40, 42 is equipped with a shaft 42 that defines an axis of rotation 50. Furthermore, the electric machine 10 includes power electronics 70. The power electronics 70 extend along the end side 66, which runs perpendicularly in FIG. 1. The power electronics 70 may include power capacitors (illustrated by the uppermost and the lowermost rectangle 70), and also power activation stages, which are illustrated by the two rectangles 70 that lie between the uppermost and lowermost rectangle.

The power end stages may include a cooling surface with cooling fingers or similar structures for increasing the surface, which cooling fingers or similar structures project into the end side section 66 of the cooling duct or to which the cooling duct is adjacent. In some examples, a bearing shield 72 seals the housing 20 on the end side as illustrated in FIG. 1 and furthermore serves to mount the shaft 42 rotatably by means of a rolling bearing.

The stator 30 may include a winding body 30 and an adjoining winding head 32. The longitudinal section 62, 64 may be divided into a first subsection 62 and a second subsection 64. The first subsection 62 extends along the longitudinal direction (with respect to the axis 50) of the stator 30 and therefore along the winding body 30. The second subsection 64 extends along the circumferential surface of the winding head 32. The second subsection 64 adjoins the first subsection 62 of the longitudinal section.

In some examples, the second subsection 64 (and therefore the longitudinal section) merges into the end side section 66 at that end of the winding head 32 that faces away from the winding body 30.

FIG. 1 shows that, from a part of the first subsection 62 that is illustrated at the top in FIG. 1, the heat medium merges from the (part of the) first subsection 62 into a part of the second subsection 64. At the end of the longitudinal section or of the second subsection, the flow direction changes (substantially by an angle of 90°).

As illustrated in FIG. 1, after the longitudinal section, the cooling medium no longer flows along the direction in which the shaft 42 extends, but rather flows toward the shaft 42 or flows around the shaft 42 before/upon reaching the shaft 42 in order, as illustrated in the lower half of the FIG. 1, to arrive at a second part of the longitudinal section, which is illustrated in the lower half of the FIG. 1 and bears the reference sign 64. With the lower part of the longitudinal section, the heat medium is transported away from the end side section 66 of the cooling duct, first of all via a (part of the) second section 64 and then via a (part of the) first section 62, which leads in turn to a heat medium outlet. The direction of flow in the end side section 66 therefore firstly leads toward the shaft, and also away from the shaft and in particular leads in the vicinity of the shaft, that is to say around the shaft or around the section which supports the latter, shortly before reaching that section of the bearing shield 72 which supports the shaft. As such, in some examples, the direction of flow in the end side section 66 is substantially perpendicular to the direction of flow in the longitudinal section 62, 64.

In some implementations, the direction of flow in the lower part of the longitudinal section 62, 64 is opposite to the direction of flow in the upper part of the longitudinal section 62, 64. Referring to FIG. 1, in some examples, a wall divides the longitudinal section into two parts. One of the parts of the longitudinal section conducts the medium (from a heat medium inlet) toward the end-side section 66, while the other part of the longitudinal section, illustrated at the bottom of FIG. 1, leads the heat medium away from the end side section 66 (and conducts same to a heat medium outlet).

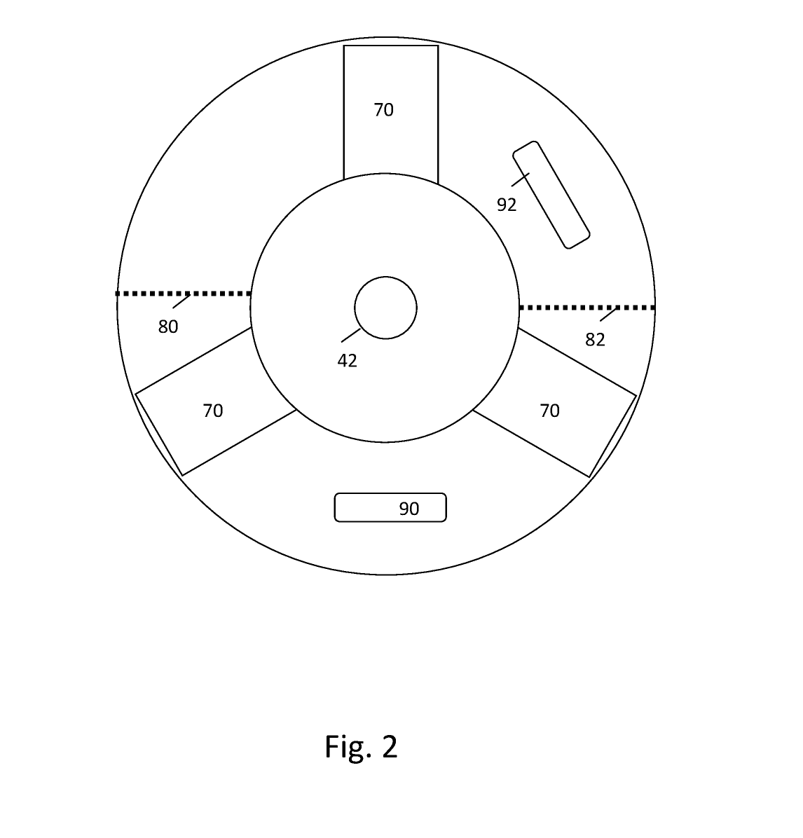

The power electronics 70 shown in the upper half of FIG. 1 are also shown in the lower half of FIG. 1. As such, the power electronics 70 are opposite each other with respect to the longitudinal axis 50. However, this is a simplified illustration, wherein the power electronics are not necessarily allocated to segments, of which two are exactly opposite each other with respect to the longitudinal axis 50 (i.e. are offset by 180° to each other). Instead, the power electronics may also be distributed in another way, as is illustrated, for example, in FIG. 2.

FIG. 2 illustrates a top view of an exemplary electric machine 10. The power electronics 70 are distributed to three sections (which are also referred to here as segments). The segments are arranged by 120° with respect to one another (in the circumferential direction of the stator 30).

While the power electronics 70 are located on a bearing shield or on an end side of the electric machine 10 which is opposite the end side illustrated in FIG. 1 or the bearing shield 72, a heat medium inlet 90 and a heat medium outlet 92 are located on the end side opposite thereto. The heat medium inlet 90 and the heat medium outlet 92 are provided within a bearing shield 72 positioned opposite the bearing shield 72 illustrated in FIG. 1.

In some examples, a wall 80, 82 extends over two sections and divides, as illustrated schematically in FIG. 2, the hollow-cylindrical space between the stator 30 and the housing 20 such that two (generally a plurality of) cut hollow cylinders are produced. While one cut hollow cylinder is provided at the heat medium inlet, another cut hollow cylinder is connected to the heat medium outlet. As a result, as in FIG. 1, in the upper half of the figure in FIG. 2, a first coolant direction is produced along the circumferential surface of the stator 30, which coolant direction is opposed to the coolant direction in the lower half of the figure.

As is illustrated in FIG. 2, in some examples, the wall 80, 82 is divided into a first longitudinal section 80 and a second longitudinal section 82. The longitudinal sections 80, 82 may run substantially in a plane, through which the shaft 42 also extends. However, this is not absolutely necessary, and therefore the longitudinal sections 80, 82 may be provided on sides of the electric machine 10 that are opposite each other in cross section, but do not necessarily have to be offset with respect to one another by 180° in the circumferential direction of the stator.

In the case of the division illustrated in FIG. 2, into two (or more than two) equally sized cut hollow cylinders, the advantage is produced that the section of the cooling duct toward the end surface section has the same cross-sectional area as that section of the cooling duct which leads away from the end side section.

In some examples, a plurality of heat medium inlets and/or a plurality of heat medium outlets are provided, wherein the inlets or outlets are each separated by a wall—as illustrated by a dotted line in FIG. 2.

A number of implementations have been described. Nevertheless, it will be understood that various modifications may be made without departing from the spirit and scope of the disclosure. Accordingly, other implementations are within the scope of the following claims.

What is claimed is:

1. An electric machine comprises:
a housing including power electronics, the housing defined by a longitudinal section and an end side section;
a rotor including a shaft;
a stator embracing the rotor; and
a cooling duct extending along the longitudinal section and along the end side section, the longitudinal section extends along a hollow cylinder, through the interior of which the axis of rotation of the shaft leads, and the end side section extends toward the shaft.

2. The electric machine of claim 1, wherein the longitudinal section is bounded by a circumferential surface of the stator on one side and a wall of the housing on the other side, and wherein the end side section is bounded by an end side of the stator on one side and of the power electronics on the other side.

3. The electric machine of claim 1, wherein the power electronics extend along an annular surface, through the center of which the shaft pushes, the power electronics have a cooling surface which bounds the end side section.

4. The electric machine of claim 1, wherein the longitudinal section merges directly into the end side section, the cross section of the longitudinal section extends between the stator and the housing, and the cross section of the end side section extends between the stator and the power electronics.

5. The electric machine of claim 1, wherein the longitudinal section comprises a first subsection which is bounded by a circumference of a winding body, and a second subsection which is bounded by a circumference of a winding head of the stator, the first subsection is connected via the second subsection to the end side section, and the end side section is bounded by an end side of the winding head.

6. The electric machine of claim 1, further comprising a bearing shield having an inner side which bears the power electronics, the shaft is mounted rotatably by means of a bearing of the bearing shield, and the shaft pushes through the bearing shield.

7. The electric machine of claim 1, wherein the longitudinal section is divided into at least two parts by at least one wall, the wall firstly extends from the stator to the housing and secondly extends in a direction along which the shaft runs.

8. The electric machine of claim 1, further comprising a heat medium inlet and a heat medium outlet, between which the cooling duct extends, the heat medium inlet and the heat medium outlet arranged on the same end side of the housing on an end side opposite the end side on which the end side section is provided.

9. The electric machine of claim 8, wherein the heat medium inlet and the heat medium outlet run through a further bearing shield which, with respect to the electric machine is opposite a bearing shield which bounds the end side section and in particular bears the power electronics.

10. The electric machine of claim 1, wherein the longitudinal section extends along a plurality of cut hollow cylinders which are divided into sectors in the direction of longitudinal direction of the shaft, wherein the cut hollow cylinders and end sides of different hollow cylinders are connected to one another via the end side section.
